(19) United States
(12) Patent Application Publication
(10) Pub. No.: US 2003/0174512 A1
(43) Pub. Date: Sep. 18, 2003

(54) Headlight

(76) Inventor: Holger Rohr, Eisenach (DE)

Correspondence Address: STRIKER, STRIKER & STENBY, 103 East Neck Road, Huntington, NY, 11743, US

(21) Appl. No.: 10/387,066

(22) Filed: Mar. 12, 2003

(30) Foreign Application Priority Data
Mar. 16, 2002 (DE) 202 04 244.8

(51) Int. Cl. F21V 19/02

(52) U.S. Cl. 362/523; 362/273; 362/285; 362/271; 362/419

(57) ABSTRACT

A headlight having a light module, adjusting units adjusting said light module and formed so that a vertical adjustment is performed independently from a horizontal adjustment, said adjusting units including adjusting devices; a cover cap which covers at least one of said adjusting devices; a headlight housing, said cover cap being connected of one-piece turnably with said headlight housing and having an arresting structure which is arrestable with a corresponding arresting units on said headlight housing.

### BACKGROUND OF THE INVENTION

The present invention relates generally to headlights. More particularly, it relates to a headlight which has a light module, and also adjusting devices for the light module, wherein the vertical adjustment can be performed independently from the horizontal adjustment.

Headlights are known in the art, in which the orientation of their light module can be adjusted vertically or horizontally. This adjustment is carried out on the one hand by a vehicle manufacturer during the manufacture to compensate tolerances of the whole vehicle, and also on the other hand by monitoring devices such as for example the TUV to ensure the adjustment or regulation of the headlight units with respect to the legal requirements.

It is basically possible to adjust the headlight with the use of the independent adjustments, wherein for example the height adjustment must be regulated by actuation of two adjusting elements, namely for the height adjustment and for the side adjustment. It is possible also to adjust the headlight by a not dependent adjustment, wherein both adjustments, both the height adjustment and the side adjustment or in other words horizontal and vertical, can be carried by separate adjusting devices.

It can be basically provided that the headlight can have more than one vertical and horizontal adjusting point, wherein also with the not dependent adjustment an adjustment by means of several adjusting means can be provided.

Legal regulations of some countries, for example the United States, forbid the accessibility of the horizontal adjusting device during the utilization of for example the visual-optical adjustment (FMVSS) and intend to prohibit a possible fine adjustment of the headlight by the end user. It must be avoided that a blinding of the countertraffic can occur as a result of a false base adjustment. When the user carries out the horizontal adjustment incorrectly, then due to an adjustment of the light range regulation this can lead with an increasing load condition of the vehicle to blinding of the countertraffic.

Therefore in such headlights it is provided that the outwardly accessible adjustments are made unaccessible. This is achieved as a rule by the use of an additional component or by the application of an adhesive in the adjusting device. In the most cases a bevel gear with an intersecting slot is provided as the adjusting device. The intersecting slot is filled for example with adhesive so that the adjusting screws can no longer be actuated.

### SUMMARY OF THE INVENTION

Accordingly, it is an object of the present invention to provide a headlight of the above mentioned general type, which avoids the disadvantages of the prior art.

More particularly, it is an object of the present invention to provide a headlight, in which a covering of the adjusting device can be performed in a simple manner and reliably.

In keeping with these objects and with others which will become apparent hereinafter, one feature of the present invention resides, briefly stated, in a headlight in which at least one of the adjusting devices is covered by a cover cap, wherein the cover cap is turnably connected of one piece with a headlight housing, and has arresting means which are arrestable with corresponding arresting means on the headlight housing.

With this approach advantageously the introduction of an additional part or an additional material can be avoided for making the outwardly accesible adjusting means for the vertical adjustments and also for example for the horizontal adjustments unaccessible for the end user. As a rule, several adjustments are provided for an individually suspended headlight module.

With the approach when the headlight is designed in accordance with the present invention, the mounting expenses can be significantly reduced as well.

In accordance with a further preferable embodiment of the invention, the cover cap and/or the arresting means of the headlight housing can be injection molded on the headlight housing.

When housings are composed In particular of synthetic plastic material, it is possible in this way to provide a mounting and fixing of the cover cap in a simple manner. Also, the arresting means are secured on the headlight housing, for arresting the corresponding arresting means of the cover cap with the arresting means on the headlight housing. The mounting of the cover cap as well as the arresting means can be performed in a single working step during the manufacture of the headlight housing. The number of parts is therefore reduced.

It can be also provided that the cover cap is connected with the headlight housing through a film hinge. The film hinge can be formed by material reduction, and also by perforations. Therefore, turning of the cover cap around the film hinge is possible.

The arresting means in accordance with the present invention can be connectable with one another with the use of a form-locking connection.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing an adjusting device for a headlight in accordance with the present invention;

FIG. 2 is a view showing a portion identified as A in of the adjusting device shown in FIG. 1; and

FIG. 3 is a side view of the adjusting device shown in FIG. 1 in accordance with the present invention.

### DESCRIPTION OF THE PREFERRED EMBODIMENTS

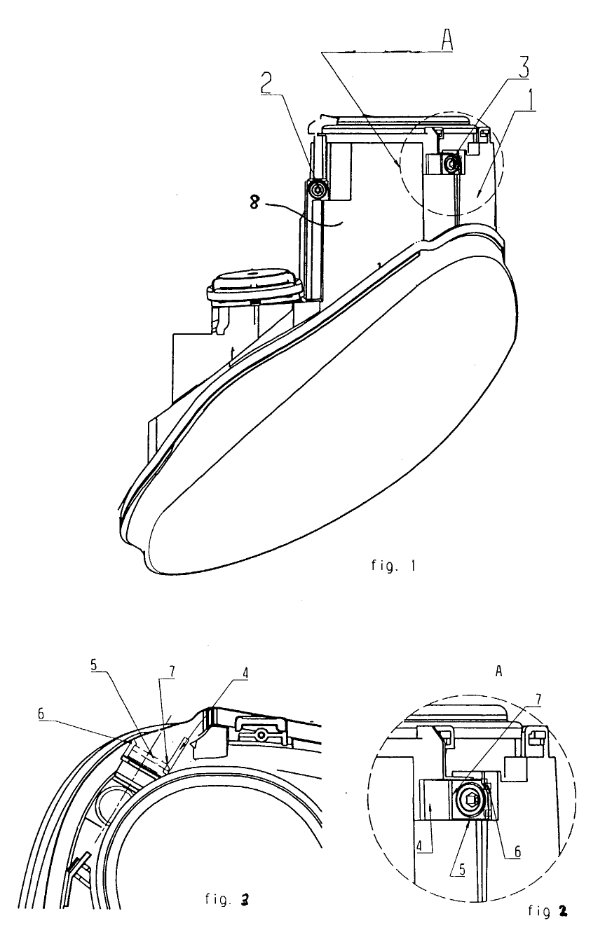

FIG. 1 shows a headlight which is identified as a whole with reference numeral 1. The headlight has a light module which is adjustable by a not dependent adjustment vertically by means of an adjusting device 2 and horizontally by means of an adjusting device 3.

Because of the legal regulations of certain countries, it is required to make the accessibility of the horizontal adjusting device 3 not possible for the end consumer.

For this purpose a swivelable element 4 is provided on a headlight housing 8, as can be seen from FIG. 2. The swivelable element 4 which is shown in FIG. 2 in an open position, is swivelable around an axis 7. It is directly injection molded on the headlight housing 8, or in other words is connected by a continuous material connection and one piece with the headlight housing 8.

The swivelable element 4 can be formed as a cover cap. In the region of the rotary axis 7 the swivelable element 4 or the cover cap has a film hinge. Therefore the cover cap 4 can turn around the rotary axis 7 with bending of the film hinge. Moreover, the cover cap 4 has arresting elements which are formed here by the outer surface of the cover cap or in other words by the cover element itself. Further arresting elements 6 are provided on the headlight housing and can be also injection molded on it.

When the cover cap 4 is bent around its rotary axis 7, the swivelling can be performed until the cover cap 4 engages under the arresting elements 6 provided for this purpose with an arresting projection for engaging the cover cap 4. The cover cap can be arrested in this end position which is shown in broken lines in FIG. 3, in which the swiveling from the open condition shown in solid lines to the end position is performed. Thereby the non-accessibility of the outwardly accessible horizontal adjusting device 3 is guaranteed.

Basically it is possible to provide such cover caps on other parts of the headlights which must be not accessible from outside or on parts which must be not influenced by exterior actions, such as for example splash guard on ventilation sockets, plugs and protective hoods, etc.

It will be understood that each of the elements described above, or two or more together, may also find a useful application in other types of constructions differing from the types described above.

While the invention has been illustrated and described as embodied in a headlight, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A headlight, comprising a light module; adjusting means adjusting said light module and formed so that a vertical adjustment is performed independently from a horizontal adjustment, said adjusting means including adjusting devices; a cover cap which covers at least one of said adjusting devices; a headlight housing, said cover cap being connected of one-piece turnably with said headlight housing and having arresting means which are arrestable with corresponding arresting means on said headlight housing.

2. A headlight as defined in claim 1, wherein said cover cap of said headlight housing is composed of a synthetic plastic material and injection molded on said headlight housing.
